(19) United States
(12) Patent Application Publication
(10) Pub. No.: US 2013/0008368 A1
(43) Pub. Date: Jan. 10, 2013

(54) Temperature indication product and method of manufacture

(76) Inventors: Jamie Greenberg, Lake Forest, IL (US); Michael A. Macchiarelli, Shelton, CT (US)

(21) Appl. No.: 13/135,463

(22) Filed: Jul. 6, 2011

(51) Int. Cl. G01K 1/02; B29C 67/02

(52) U.S. Cl. 116/216; 264/117

(57) ABSTRACT

Finely divided particles preferably formed into tablets or into pellets of granular temperature indication material are used as a thermometer and are brought into contact with a surface to measure surface temperature by a change in appearance of the indication material at a known temperature. Pellets are made from comminuted solid temperature indicating material shaped into a pill or tablet. In a version of the invention different temperatures are indicated by separate parts of the product, such as by separate stacked layers assembled as a composite unit to form an article of manufacture.

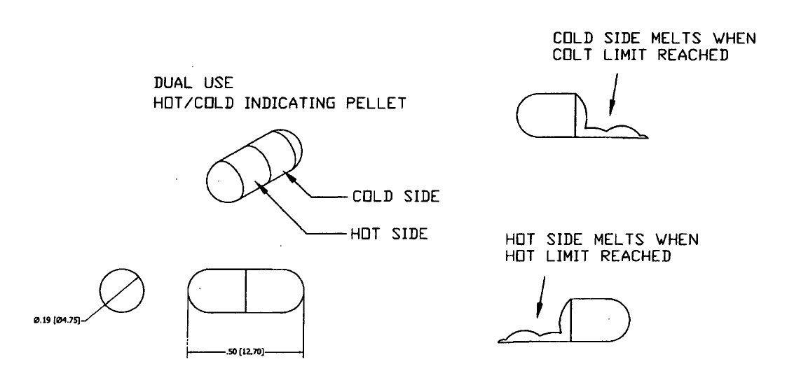

This invention relates to novel thermometer products and to methods of manufacture and of use thereof. A thermally stable core substrate is formed by molding or casting from powder or liquid into a shaped structure or article and is combined with a separate layer or core of thermally responsive indicator material which changes in character at a predictable temperature after the core substrate and responsive layer both reach a known predictable temperature.

### PRIOR ART

It is known in the prior art to use thermally reactive materials to indicate product temperature. This is done, for example, by application of temperature indicating reactive materials onto a test surface as coatings, such as crayons, lacquers, or paints; products are also optionally formed into shaped articles such as pellets, tablets, pills or capsules from thermal indicating compositions comprising finely divided comminuted particles or powder; other prior temperature indicating means include use of contact and/or radiant or infrared thermometers.

### PRODUCT OF THE INVENTION

The product of this invention relies upon indicating temperature by a change in appearance or character of a structural component element, which is observed to appear in a characteristic way at at least one predictable temperature, such as by a change in its physical state, (e.g. melting), or by a change in electrical conductivity. The indicating component of the product may be formed or incorporated with a substrate element, or applied thereto as a surface pattern so as to form letters or numbers thereupon to show temperature. Different indicators are applied to or combined physically with the substrate element or component. At a pre-established temperature an outer shell, or a combination of shell and contained substrate, breaks down to release enclosed reactive indicating elements.

Pills, pellets or tablets of the invention are packaged by size, color or by shape to indicate to the user the temperature responsive range of the product. Separate multiple temperatures are indicated by a single pellet. The pellet version product of the invention contains both low and high temperature indicating features which establish temperature boundary conditions or limits. Thus a single pellet indicates when either an upper or lower temperature is exceeded. When temperature critical products are shipped, such as food or medication, the pellet memory indicates if a shipment ever became too hot or too cold during transit. The invention is useful when a process requires treatment between different particular temperatures, such as in food cooking or in industrial processes.

### METHOD OF THE INVENTION

The method of the invention involves the following steps: 1) selecting a particular known temperature indicating material for each separate temperature to be identified, in a form such as a liquid, a powder or a coating, or as a spray which is supplied from a dispenser means or device; 2) selecting a temperature stable substrate which lends form, shape and dimensions to the core structure of the product which is cast or molded there from; 3) combining, as by mixing or by coating, the temperature indicating material and the substrate material in portions of suitable size to form a shaped article of manufacture, for use as a temperature indication tablet, pellet or the like. Temperature pellet products are formed by a standard industrial tablet or capsule making machine from the combination of a substrate composition and an indicating component, for example, into a pellet, table or capsule. More than one temperature may be determined by simultaneous use or mixture of separate kinds of pellets together. This is also done by staking pellets together in layers wherein each layer is activated at a different temperature and the layers are bound together by adhesive or welding, for example, as a vertical or horizontal stack of coins.

### EXAMPLE

An example of the best mode of practicing the preferred expression of the invention is to form a pellet comprising a substrate inert core encased in an outer shell or coating, which includes known thermally responsive material which changes between a liquid and a solid state at a known temperature, or changes in appearance or in color, or changes in electrical properties which indicate known temperatures.

Another method of making the product of the invention involves combining a structural substrate which lends form and dimension to either a pellet or to a granular product, which is next coated or enrobed or painted with a temperature indicating composition to produce a composite thermometer product which is cut from a larger structural version; or shaved or flaked to produce a comminuted structure.

Another form of the invention embodies a particulate coating of thermally responsive indicating particles adhered to the surface of solid sheet material, such as in the form of a sand paper structure, wherein particles adhere by adhesive coating or by particle stickiness induced by melting the support surface or by coating/treating a layer of particles to adhere them onto the support surface; or whereby either particle or surface is made sticky.

### DRAWING

The annexed drawing shows the construction and operation of a multi-temperature indicating product, as a pellet, in cartoon format as five sequential figures.

1. An article of manufacture comprising a solid shaped pellet of material which includes separate elements which change in observable form at a predictable temperature, and is used as a thermometer.

2. A method of making a thermometer pellet by the steps of (a) forming a pellet shape structure from comminuted solid particles; and (b) combining with said structure a component of at least one temperature indicating material as an element which changes in appearance at a selected predictable temperature.

3. An article according to claim 1 in which a pellet comprises separate layers of temperature indication material and wherein each layer responds to different temperature change, so that hot and cold temperatures are distinguished by change in pellet appearance.

4. An article according to claim 1 comprising separate hot and cold temperature indicating bands or layers which form composite unit which is stackable in horizontal or vertical format.

5. An article according to claim 1 comprising sheet material, coated with particles of temperature indicting material, which changes in appearance at different temperatures.
